(19) United States
(12) Patent Application Publication
(10) Pub. No.: US 2006/0285534 A1
(43) Pub. Date: Dec. 21, 2006

(54) Methods and systems for improved charging information accuracy in a wireless communication system

(75) Inventors: Sidney L. Bryson, Bolingbrook, IL (US); Min Huang, Naperville, IL (US); Randall E. Pitt, Batavia, IL (US); Steven E. Sommars, Wheaton, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/156,956

(22) Filed: Jun. 20, 2005

(51) Int. Cl. H04L 12/66

(52) U.S. Cl. 370/352; 455/405

(57) ABSTRACT

Methods and systems for improved accuracy in generation of charging data associated with packet data exchange over a wireless communication system network. Features and aspects hereof provide for periodic acknowledgment of packet data exchanged over a wireless communication network exchange between a wireless communication network and a packet data core network and to thereby permit accurate generation of charging information. Periodic acknowledgement messages are returned from the wireless communication network to the packet data core network with negligible impact on the performance of the communication link. Features and aspects hereof are particularly useful to enhance the accuracy of charging information for packet data in a 3GPP compatible wireless communication system.

### BACKGROUND OF THE INVENTION

1. Field of the Invention

The present invention relates generally to wireless communication systems wherein packet data is exchanged and where the system monitors or tracks packet data information exchanged for purposes of charging a user. More specifically, the present invention relates to methods and systems for improving the accuracy of such charging information generated in association with packet data transferred in a wireless communication system from a packet data network to a wireless device.

2. Statement of the Problem

Data exchanged in wireless communication systems often includes both voice and other non-voice data. The non-voice data in particular is often transmitted in groups of data referred to as “packets”. A sequence of packets may be transmitted to communicate a volume of data from the packet data network to the wireless device. The exchange of packetized information in such a wireless communication system has grown dramatically in recent time. In some wireless communication systems, it is important to track or monitor the volume of exchanged packet data and/or measure the bandwidth utilization of the packet data network and/or the wireless network. Where such measures are important to charging or billing a user, it is clearly important to generate charging information as accurately as possible.

A significant number of packet exchange protocols and associated systems permit absolute verification of the packet data exchanged between two devices to thereby permit generation of correspondingly accurate charging information. For example, standard TCP/IP protocol-based systems, including as applied to wireless communication systems, provide for accurate monitoring of and charging for data exchanged through a communications system. The TCP protocol requires positive acknowledgment of transmitted packets and imposes re-transmission requirements for lost packets. Such a reliable protocol imposes significant overhead as compared to, for example, UDP or other packet oriented protocols.

On the other hand, a significant number of communication systems utilize protocols that do not ensure accurate charging for data exchanged. For example, some streaming audio and video applications eliminate the need for frequent protocol handshakes and retransmissions so as to improve overall available bandwidth for use in the transfer of data. By so reducing or eliminating handshake information and associated retransmissions, such protocols make it difficult to accurately monitor the volume or rate of data so exchanged and hence difficult to accurately charge for the data.

Where the communication system protocols employed make it difficult to accurately track data transfer volume or bandwidth, it is similarly difficult to generate accurate charging information. Consumers of the communications system products and services typically demand accurate billing. Systems incapable of providing accurate charging information may therefore present a variety of problems. In other words, either the customer may be overcharged or the service provider may be forced to underestimate or undercharge for the provided services.

These issues are particularly noteworthy in the context of, for example, a universal mobile telecommunications system (“UMTS”) compliant with the 3GPP standards. The 3GPP standards call for use of unreliable protocols—specifically the UDP protocol—between various components involved in the exchange of packet data in a wireless communication system. In particular, the 3GPP UMTS standards specify use of an unreliable protocol (i.e., such as UDP) in transferring packet data from a packet data network to a wireless network controller. Since the specified protocol in the 3GPP UMTS standards for transferring packet data from a packet data network to a wireless network controller is an unreliable protocol, it is an ongoing problem for UMTS systems to accurately charge a user for utilization of the network for such transfers. The charging information generated accounts for data sent to the wireless device—it does not however account for information that may have been sent to the wireless device but never received for any of several reasons. More specifically, when the UDP protocol is used (as called for in 3GPP standards), a user may be overcharged since charging data is generated based on information forwarded from the core network to the radio network—regardless of whether the information is actually received by the user.

It is evident from the above discussion that a need exists for improved methods and systems for generating accurate charging information in wireless communication systems typically utilizing communication protocols and standards that do not ensure accurate tracking or monitoring of the volume or bandwidth of data exchanged.

### Summary of the Solution

The present invention solves the above and other problems, thereby advancing the state of the useful arts, by providing methods and systems for improving the accuracy of charging information associated with the transfer of packetized data through a wireless communication system. More specifically, features and aspects hereof enhance the ability of a communication system to accurately generate charging information for packet data exchanged over a wireless communication network. Still more specifically, features and aspects hereof provide for the exchange of information between a packet data network and wireless communication devices in a manner to permit generation of charging information with improved accuracy. Exchanged packets are acknowledged in accordance with features and aspects hereof with negligible impact the performance of the data exchange.

A first aspect hereof provides a system that includes a wireless network controller adapted to control wireless communication with one or more wireless communication devices. The system also includes a packet data core network communicatively coupled to forward packet data to the wireless network controller and adapted to generate charging information for use by a billing system based on the packet data forwarded to the wireless network controller. The packet data core network communicates with the wireless network controller using a protocol to verify the receipt of packet data forwarded through the packet data core network to the wireless network controller to thereby improve accuracy of the charging information with respect to the packet data.

Another aspect hereof provides a method for improving charging information accuracy in a communication network. The method includes receiving packet data at a packet data core network from an external packet data network. The method also includes forwarding the packet data from the packet data core network to a wireless network controller and verifying correct receipt of the packet data by the wireless network controller. The method then generates charging information within the packet data core network for use by a billing system in response to verification or proper receipt of the packet data at the wireless network controller.

The invention may include other exemplary embodiments described below.

### DESCRIPTION OF THE DRAWINGS

The same reference number represents the same element on all drawings.

FIG. 1 is a block diagram of a wireless communication systems enhanced in accordance with features and aspects hereof to generate charging information with improved accuracy.

FIG. 2 is a block diagram of a 3GPP compliant UMTS wireless communication system enhanced in accordance with features and aspects hereof to generate charging information with improved accuracy.

FIG. 3 is a flowchart describing methods operable in a wireless communication system enhanced in accordance with features and aspects hereof to generate charging information with improved accuracy.

FIGS. 4 and 5 are flowcharts describing methods operable in a 3GPP compliant UMTS wireless communication system enhanced in accordance with features and aspects hereof to generate charging information with improved accuracy.

### DETAILED DESCRIPTION OF THE INVENTION

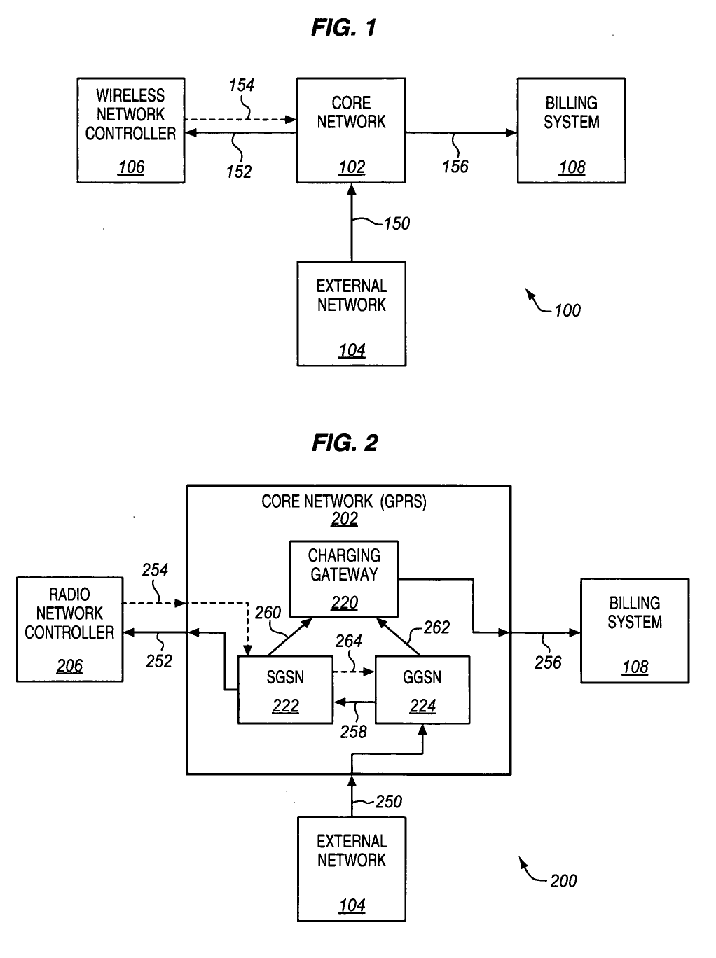

FIGS. 1-5 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 is a block diagram of a wireless communication system 100 incorporating features and aspects hereof to improve accuracy of charging information related to transmission of packet data to wireless devices (not shown) through a wireless network controller 106. System 100 may include packet data core network 102 that serves to couple an external packet data network 104 to wireless devices (not shown) through wireless network controller 106. Packet data core network 102 may receive packet data via path 150 from external packet data network 104. Exemplary of such packet data may be text messages or other mixed media information such as Internet World Wide Web information, e-mail information, etc. As noted above, numerous communication systems require charging users of such packet data based upon either utilized bandwidth of the communication network and/or the volume of data so received. Packet data core network 102 therefore includes features for generating charging information that may be later retrieved by billing system 108 via path 156.

In general, billing system 108 may operate asynchronously and independent of packet data core network 102 and may therefore request or pull such charging information according to its needs for reporting such charging information through the billing system. Alternatively, packet data core network 102 may transmit the charging information as it is generated.

Packet data core network 102 is also adapted to forward received packet data via path 152 to wireless network controller 106. As noted above, wireless network controller 106 maybe coupled through wireless, radio frequency (“RF”) transmissions to one or more wireless devices (not shown). As noted above, prior systems typically generated charging information to charge a consumer or user of the packet data as the packet data is forwarded through the packet data core network 102 to the wireless network controller 106 via path 152. As further noted above, this can cause problems where unreliable transmission protocols are utilized over path 152 between the packet data core network 102 and the wireless network controller 106. A user may be charged for packet data that never actually reached the wireless device. In numerous communication systems, such an unreliable link may be utilized to maintain higher throughput than may be achieved with more reliable protocols that include handshake acknowledgments and retransmissions for data transmissions. Generating charging information in the packet data core network 102 without verification or validation that the forwarded data was actually received at the wireless network controller 106 can cause generation of inaccurate charging information. Customers or users of such a communication system 100 would likely object to being charged for packet data that was never received.

By contrast, features and aspects hereof as shown in FIG. 1 include the generation and transmission of periodic acknowledgment messages returned from the wireless network controller 106 to the packet data core network 102 via path 154. In response to receipt of such acknowledgement messages, packet data core network 102 may then generate appropriate charging information with improved accuracy. Transmission and reception of the acknowledgment messages serves to verify correct receipt of one or more previously forwarded packets of data.

Further, the improved accuracy of the charging information permits more accurate application of time based tariffs to further improve accuracy of the generated charging information.

Those of ordinary skill in the art will recognize a wide variety of equivalent systems that may embody the features and aspects hereof exemplified in FIG. 1. For example, packet data core network 102 may comprise one or more gateway server nodes capable of receiving and transmitting messages between the external packet data network 104 and the wireless network controller 106. In addition, packet data core network 102 may include one or more gateway server nodes adapted for generating, storing, and/or maintaining charging information for use by billing system 108. Still further, packet data core network 102 may simply passively retain the stored charging information until a request is generated by billing system 108 to retrieve the charging information via path 156. Alternatively, packet data core network 102 may actively forward the charging information as it is generated to billing system 108 without the need to await a request from billing system 108. Such data exchange models are often referred to as “pulling” or “pushing” of data and are well known to those of ordinary skill in the art as a matter of design choice.

Still further, those of ordinary skill in the art will recognize that wireless network controller 106 may represent one or more communication server nodes adapted for forwarding information received from the packet data court network 102 on to any of a plurality of wireless communication devices. For example, in the context of a cellular telephony system, wireless network controller 106 may represent a base station and/or a network gateway properly configured for forwarding information between the packet data core network 102 and any of a plurality of mobile telephones.

In addition, external packet data network 104 represents any packet data network as may be common in, for example, computer data networks. For example, external packet data network 104 may represent an enterprise intranet coupling various organizations within an enterprise. External packet data network 104 may also represent public packet data networks such as the Internet or other proprietary packet data networks for exchanging digital information as packetized data.

Lastly, billing system 108 may represent any suitably programmed billing and/or accounting system useful for accepting or retrieving the charging information and entering the information appropriately into user/customer bills or invoices and/or into service provider accounting systems.

FIG. 1 is therefore intended to represent a wide variety of systems embodying features and aspects hereof to improve the accuracy of charging information relating to the transfer of packet data from an external packet data network to a wireless network controller.

Those of ordinary skill in the art will recognize that the wireless communication system 100 also provides packet data communication in the opposite direction—namely, from a wireless network controller (or wireless communication devices attached thereto) through packet data core network 102 to external packet data network 104. Such a communication path, returning packet data from the wireless network 106 to the core network 102, does not present the problems discussed herein for generating charging information. Since the packet data core network 102 controls the generation of such charging information, it may accurately charge only for packet data properly received from the wireless network controller 106. Therefore, the communication path from the wireless network controller 106 back to the external packet data network 104 for exchange of packet data is eliminated from FIG. 1 for simplicity of this description.

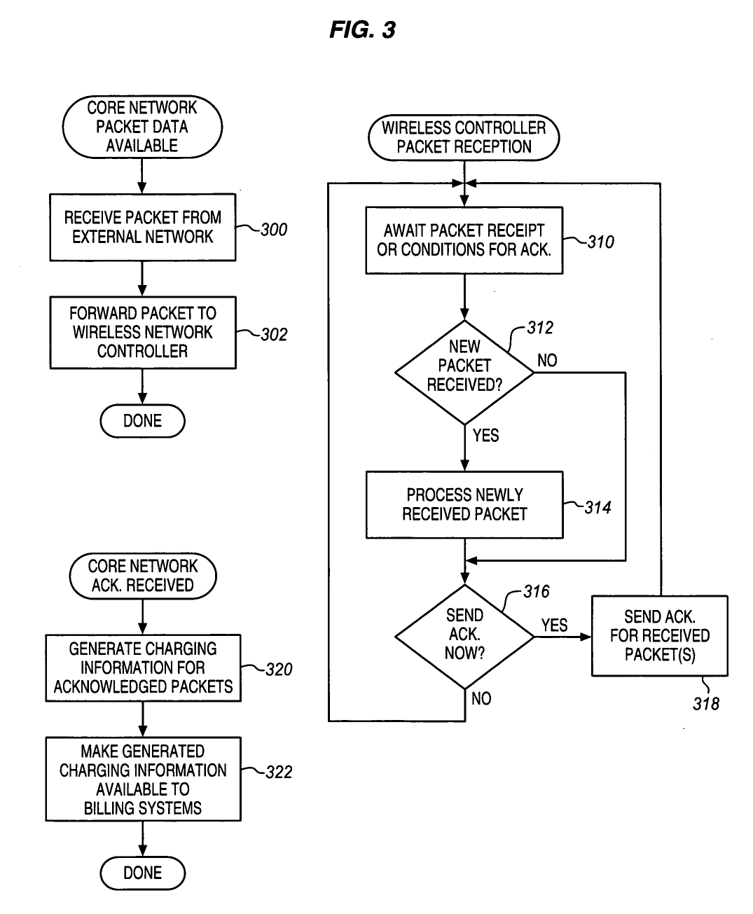

FIG. 2 shows an exemplary wireless communication system 200 beneficially applying features and aspects hereof. Communication system 200 may be, for example, a universal mobile telecommunications system (“UMTS”) compliant with the 3GPP standards. The 3GPP standards are generally available to the public at, for example, www.3gpp.org. Packet data core network 202 receives packet data via path 250 from external packet data network 104. In accordance with 3GPP standards, packet data core network 202 may provide general packet radio service (“GPRS”) to permit mobile cellular telephony users to access public data networks such as the Internet. Thus, packet data core network 202 forwards packet data received from the external packet data network 104 to the radio network controller 206 via path 252. In accordance with the 3GPP standards, radio network controller 206 is an element that controls the radio frequency resources associated with one or more mobile cellular telephony users.

In accordance with the 3GPP standards, the protocol utilized on path 252 between packet data core network 202 and radio network controller (“RNC”) 206 is unreliable and intended to maintain high throughput at the expense of reliability by eliminating the need for frequent acknowledgement handshakes and retransmissions in the protocol. In particular, 3GPP standards define a GPRS tunneling protocol (“GTP”) utilized over path 252 to forward packet data from the packet data core network 202 on to RNC 206.

In accordance with features and aspects hereof, the GTP protocol may be modified or enhanced to permit the addition of periodic acknowledgement message is returned on path 254 from the RNC 206 to the packet data core network 202. The periodic acknowledgement messages are generated by RNC 206 to indicate to verify proper receipt of some number or volume of packet data transmissions previously received via path 252.

In response to receipt of the acknowledgement messages from RNC 206 on path 254, packet data core network 202 may then generate charging information for use by billing system 108. As above, billing system 108 may request (i.e., pull) information from packet data core network 202 via path 256 or, alternatively, packet data core network 202 may transmit (i.e., push) charging information to billing system 108 as the information becomes available.

In the 3GPP model defined by publicly available standards, packet data core network 202 may implement a UMTS network including a serving GPRS support node (“SGSN”) 222 and a gateway GPRS support node (“GGSN”) 224. GGSN 224 may be a server process, network node, or network appliance generally adapted to receive packet data via path 250 from external packet data network 104. Firewall and other technical protection mechanisms may be implemented within GGSN 224. Received packet data is forwarded from GGSN 224 to SGSN 222 via path 258. SGSN 222 represents a process or node adapted to forward packet data on to the RNC 206 via path 252. As noted above, though the communication over path 252 is typically bi-directional, for simplification herein, the transmission direction from the RNC 206 back to the SGSN 222 is not shown and not relevant to this discussion.

SGSN 222 is specifically adapted to receive periodic acknowledgement messages via path 254 from RNC 206. Responsive thereto, SGSN 222 may then more accurately generate charging information (also commonly referred to as charging data records or CDRs) and may forward the generated charging information via path 260 to charging gateway 220 for eventual transmission to billing system 108. The charging information so generated by SGSN may be “pushed” to or “pulled” by billing system 108 from charging gateway 220 as required for particular billing and accounting services.

Another aspect hereof provides that the exchange of information between GGSN 224 and SGSN 222 utilizes similar enhanced GTP protocol as discussed above to similarly provide charging information generation from the GGSN 224 with improved accuracy. In accordance with the 3GPP model, GGSN 224 also generates charging information relating to the receipt of packet data from external packet data network 104. 3GPP standards provide that the link 258 between GGSN 224 and SGSN 222 also may be unreliable hence causing similar problems with inaccurate charging information generated by GGSN 224 and forwarded to charging gateway 220 via path 262. However, in accordance with features and aspects hereof, the communication protocols used over path 258 between GGSN 224 and SGSN 222 may be enhanced GTP protocols providing for periodic acknowledgement messages to be returned via path 264 from SGSN 222. Thus, as noted above for SGSN 222, GGSN 224 may thereby more accurately generate charging information and forward that charging information over path 262 to charging gateway 220. In other words, GGSN 224 generates more accurate charging information in response to the periodic acknowledgement messages received from SGSN 222 via path 264.

Also, as noted above with respect to FIG. 1, the UMTS wireless communication system 200 of FIG. 2 also provides for packet data communications in the other direction—namely from RNC 206 back through UMTS packet data core network 202, through SGSN 222 and through GGSN 224 to external packet data network 104. As above, with respect to FIG. 1, the UMTS wireless communication system 200 of FIG. 2 does not encounter the same problems of inaccurate charging information generated within the packet data core network 202 when the packet data is originated at RNC 206 and sent back to packet data core network 202 and then to packet data network 104. Thus, this reverse path of packet data communication is eliminated from FIG. 2 for simplicity of this description.

Those of ordinary skill in the art will readily recognize that a wide variety of server nodes may be utilized to implement the functions and features shown in FIG. 2. For example, packet data core network 202 may comprise one or more physical server computing nodes each adapted for particular functional aspects of packet data core network 202. Well-known distributed processing and computing paradigms permit multiple processes to be operable within any number of computing nodes. Still further, the communication paths 250 through 264 may be any suitable communication media useful for implementing such distributed computation and communication features. For example, fiber optic, coax, twisted pair, etc. communication media may be utilized where features and functions are distributed over multiple computing nodes. Further, interprocess communication paths may be utilized where functional aspects of FIG. 2 are operable within a common computing node. Such distributed computing techniques are well known to those of ordinary skill in the art.

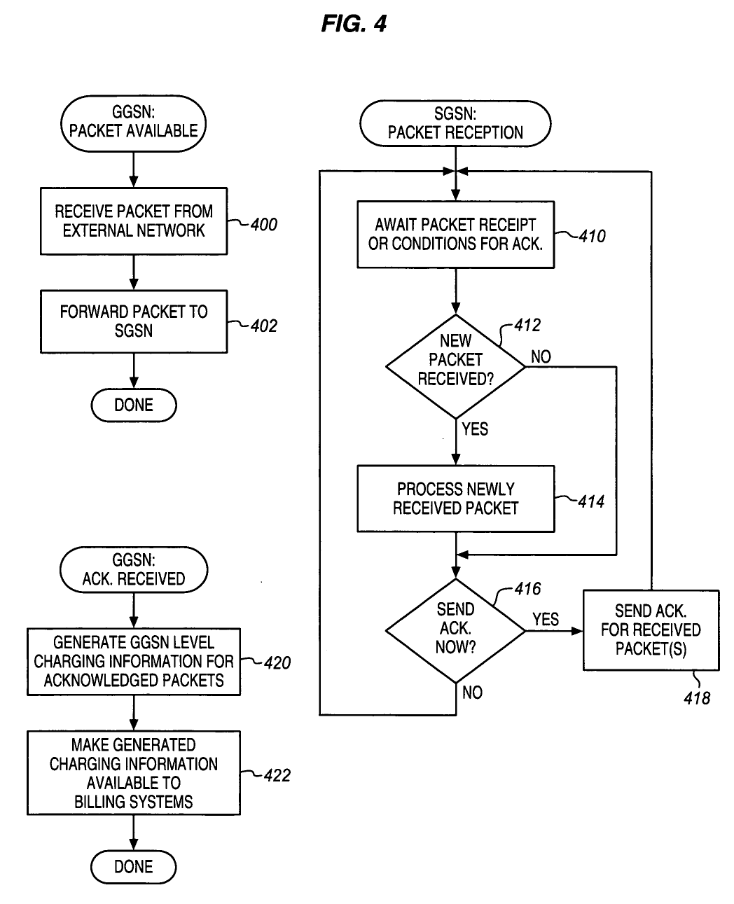

FIG. 3 is a flowchart describing related, cooperating methods in accordance with features and aspects hereof to provide improved accuracy in charging information for a wireless communication network. Elements 300 through 302 described a first aspect in which a core network has packet data available for transmission to the wireless network. Elements 310 through 318 represent an aspect of corresponding processing within the wireless controller that receives such packet data transmitted from the core network and periodically acknowledges receipt of such packet data. Lastly, elements 320 through 322 represent processing aspects, again within the core network, to receive the periodic acknowledgement messages and to generate charging information in response thereto.

Elements 300 through 302 correspond to processing within the packet data core network to forward a received packet from the external packet data network to the wireless network controller of the wireless communication system. Element 300 is first operable to receive the available packet data from the external packet data network. Element 302 then transmits or forwards the received packet data to the wireless network controller. Those of ordinary skill in the art will recognize that any other variety of packet data protocols may be utilized for the transmission and reception of such packet data.

Elements 310 through 318 represent related processing operable within the wireless network controller of the wireless communications system to receive the transmitted packet data and to periodically acknowledge packet data previously received. Elements 310 through 318 may be continuously and iteratively operable within the wireless network controller of the wireless communication system. In general, the method periodically generates acknowledgement messages and processes newly received packets.

Element 310 is operable await a determination whether an acknowledgement message should be sent at this time or a packet has been received. The determination as to when periodic acknowledgement messages should be sent may be made in accordance with any number of parameters of the wireless communications system. Periodic acknowledgement messages may be sent in accordance with monitoring elapsed time such that messages are sent based on chronological passage of time. For example, an acknowledgment message may be sent every N seconds or minutes where N is a programmable parameter of the wireless communication system. In addition or in the alternative, acknowledgement messages may be sent based on a volume of packet data received. For example, when the volume of packet data received exceeds a predetermined threshold value, an acknowledgement message may be sent. Still further, any combination of these and other factors may be used to determine whether an acknowledgment message should be sent at this time. Element 310 therefore represents processing for awaiting receipt of a new packet or a determination that an acknowledgement message should be sent at the present time based on elapsed time, volume of packet data received, other parameters of the wireless communication system, or any combination of such parameters.

If element 310 determines that an acknowledgement message should be sent now, or that a new packet has been received, element 312 is next operable to determine whether a new packet has been received from the packet data core network. If so, element 314 is next operable to process the newly received packet including, for example, forwarding the information through the wireless network to an intended wireless communication device. In either case, processing then continues at element 316.

Element 316 then determines whether it is now time to send an acknowledgment message to the packet data core network. If not, processing continues looping back to element 310. If element 316 determines that an acknowledgment message should be sent now, element 318 is next operable to generate and transmit an appropriate acknowledgement message back to the packet data core network. Such an acknowledgement message may indicate which specific data packets are being acknowledged by the message or, more generally, may simply indicate the volume of received packet data being acknowledged by the message. Processing then continues with element 310. Elements 310 through 318 are therefore continuously and iteratively operable to periodically generate and transmit acknowledgement messages from the wireless controller network back to the packet data core network and to process any new packet data received from the packet data core network.

Elements 320 through 322 then represent corresponding processing again within the packet data core network responsive to receipt of an acknowledgment message from the wireless network controller. Element 320 is operable responsive to receipt of the acknowledgement message to more accurately generate charging information for the packet data acknowledged by the received acknowledgement message. As noted above, the acknowledgement message may indicate the specific packets being acknowledged or may indicate a volume of packet data to be acknowledged by the message. The generated charging information is then made available to associated billing systems by operation of element 322. In particular, element 322 may store the accurately generated charging information in an appropriate area for retrieval by billing systems or may transmit the charging information to a corresponding billing system. Such design choices for pushing or pulling the charging information to billing systems will be readily apparent to those of ordinary skill in the art.

Those of ordinary skill in the art will recognize that the independent processes represented by elements 300 through 302, elements 310 through 318, and elements 320 through 322 may operate asynchronously with respect to one another and may operate on any number of processing element. Such distributed processing design choices are well known to those of ordinary skill in the art. Further, those of ordinary skill in the art will recognize that the communication path and methods used for transmitting the acknowledgement message back to the core network (e.g., from RNC to SGSN or from SGSN to GGSN) may be unreliable. Numerous well known protocol and validation techniques and structures may be employed if an acknowledgement message is lost or missed

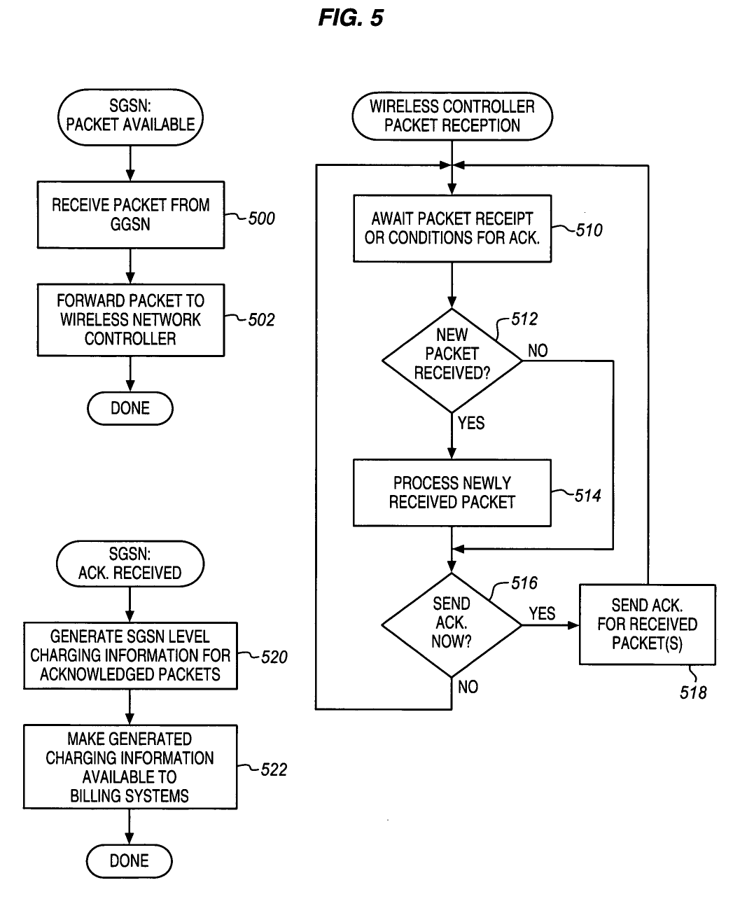

FIGS. 4 and 5 are nearly identical flowcharts to that of FIG. 3 describing a particular exemplary embodiment of the method of FIG. 3 as applied to a 3GPP compliant UMTS wireless communications system (such as that depicted in FIG. 2 and described above). As described above in FIG. 2, a 3GPP compliant UMTS packet data core network GPRS server system may include an SGSN and a GGSN for coupling the UMTS core network to the wireless network and to the external packet data network, respectively. Also as noted above with respect to FIG. 2, a similar periodic acknowledgement enhancement to the GTP protocol may be utilized both in the SGSN to wireless network controller RNC link and in the GGSN to SGSN link for forwarding packet data received from the external packet data network.

FIG. 4 represents similar processing to that of FIG. 3 as applied to the GGSN to SGSN GTP link for forwarding packet data received from an external packet data network through the GGSN to the SGSN. Elements 400-402 and 420-422 are operable in a GGSN similar to the manner in which elements 300-302 and 320-322 are operable in the core network method of FIG. 3 and elements 410-418 are operable in the SGSN in a manner similar that of 310-318 in the wireless network controller as in FIG. 3.

FIG. 5 represents similar processing to that of FIG. 3 as applied to the SGSN to RNC GTP link for forwarding packet data received from an external packet data network (via the GGSN) through the SGSN to the RNC. Elements 500-502 and 520-522 are operable in a SGSN similar to the manner in which elements 300-302 and 320-322 are operable in the core network method of FIG. 3 and elements 510-518 are operable in the RNC in a manner similar that of 310-318 in the wireless network controller as in FIG. 3.

We claim:

1. A system comprising:
a wireless network controller adapted to control wireless communication with one or more wireless communication devices; and
a packet data core network communicatively coupled to forward packet data to the wireless network controller and adapted to generate charging information for use by a billing system based on the packet data forwarded to the wireless network controller,
wherein the packet data core network communicates with the wireless network controller using a protocol to verify the receipt of packet data forwarded through the packet data core network to the wireless network controller to thereby improve accuracy of the charging information with respect to the packet data.

2. The system of claim 1 wherein the wireless network controller is adapted to receive the packet data from the packet data core network and is further adapted to transmit an acknowledgment message to the packet data core network verifying receipt of packet data.

3. The system of claim 2 wherein the wireless network controller is further adapted to transmit the acknowledgment message based on a configurable parameter.

4. The system of claim 3 wherein the configurable parameter is selected from the group consisting of: quantity of received packet data, elapsed time, and a combination of either or both the quantity of received packet data and the elapsed time.

5. The system of claim 1 wherein the communication network is a 3GPP universal mobile telecommunication system (“UMTS”),
wherein the wireless network controller further comprises a radio network controller (“RNC”) adapted to receive packet data from the packet data core network and further adapted to transmit an acknowledgment message to the packet data core network verifying receipt of packet data,
wherein the packet data core network provides general packet radio service (“GPRS”) and includes a serving GPRS support node (“SGSN”) coupling the RNC to the packet data core network,
wherein the SGSN is adapted to forward packet data to the RNC and is adapted to receive the periodic acknowledgment messages from the RNC, and
wherein the SGSN generates charging information in response to the receipt of the periodic acknowledgment messages.

6. The system of claim 5
wherein the SGSN and RNC are both adapted to use a GPRS tunneling protocol (“GTP”) modified to transmit and receive the periodic acknowledgment messages between the RNC and the SGSN.

7. The system of claim 5
wherein the packet data core network further includes a gateway GPRS support node (“GGSN”) coupled to the SGSN and adapted for coupling the packet data core network to an external packet data network and adapted to forward packet data received from the external packet data network to the SGSN,
wherein the SGSN is adapted to transmit an acknowledgment message to the GGSN verifying receipt of the forwarded packet data,
wherein the GGSN is further adapted to receive the periodic acknowledgment messages from the SGSN, and
wherein the GGSN generates charging information in response to the receipt of the periodic acknowledgment messages received from the SGSN.

8. The system of claim 7
wherein the SGSN and GGSN are both adapted to use a GTP modified to transmit and receive the periodic acknowledgment messages between the SGSN and the GGSN.

9. A method for improving charging information accuracy in a communication network, the method comprising:
receiving packet data at a packet data core network from an external packet data network;
forwarding the packet data from the packet data core network to a wireless network controller;
verifying correct receipt of the packet data by the wireless network controller; and
generating charging information within the packet data core network for use by a billing system in response to verification or proper receipt of the packet data at the wireless network controller.

10. The method of claim 9 wherein the step of verifying further comprises:
transmitting an acknowledgment message from the wireless network controller to the packet data core network; and
receiving the periodic acknowledgment message at the packet data core network to thereby verify receipt of the packet data at the wireless network controller.

11. The method of claim 10 wherein the step of transmitting further comprises:
transmitting an acknowledgment message from the wireless network controller to the packet data core network based on a configurable parameter.

12. The method of claim 11 wherein the step of transmitting based on a configurable parameter further comprises:
transmitting an acknowledgment message from the wireless network controller to the packet data core network based on a configurable parameter selected from the group consisting of: quantity of received packet data, elapsed time, and a combination of either or both the quantity of received packet data and the elapsed time.

13. The method of claim 10
wherein the communication network is a 3GPP universal mobile telecommunication system (“UMTS”),
wherein the wireless network controller comprises a radio network controller (“RNC”),
wherein the packet data core network provides general packet radio service (“GPRS”) and includes a serving GPRS support node (“SGSN”) coupling the RNC to the packet data core network,
wherein the SGSN is adapted to forward packet data to the RNC and is adapted to receive the periodic acknowledgment messages from the RNC, and
wherein the SGSN generates the charging information in response to the receipt of the periodic acknowledgment messages from the RNC.

14. The method of claim 13
wherein the packet data core network further includes a gateway GPRS support node (“GGSN”) coupled to the SGSN, and
wherein the GGSN is adapted for coupling the packet data core network to an external packet data network,
wherein the method further comprises:
receiving external packet data at the GGSN from the external packet data network;
forwarding the external packet data from the GGSN to the SGSN;
verifying correct receipt of the external packet data by the SGSN; and
generating charging information within the GGSN for use by a billing system in response to verification or proper receipt of the packet data at the SGSN.

15. The method of claim 14 wherein the step of verifying proper receipt of the external packet data at the SGSN further comprises:
transmitting an acknowledgment message from the SGSN to the GGSN; and
receiving the periodic acknowledgment message at the GGSN to thereby verify receipt of the packet data at the SGSN.

16. A 3GPP compliant universal mobile telecommunication system (“UMTS”) implementing general packet radio services (“GPRS”), the system comprising:
a radio network controller (“RNC”) adapted for communication with one or more wireless communication devices and adapted for communication with a packet data network;
a serving GPRS support node (“SGSN”) coupling the RNC to a packet data core network;
a gateway GPRS support node (“GGSN”) coupling the SGSN to an external packet data network; and
a charging information gateway coupled to the SGSN and coupled to the GGSN for receiving charging information from the SGSN and from the GGSN regarding forwarding of packet data from the external packet data network through the GGSN and through the SGSN to the RNC,
wherein the SGSN is adapted to generate charging information for transmission to the charging information gateway in response to verifying receipt of packet data forwarded through the SGSN to the RNC, and
wherein the GGSN is adapted to generate charging information for transmission to the charging information gateway in response to verifying receipt of packet data forwarded through the GGSN to the SGSN.

17. The system of claim 16
wherein the RNC is adapted to generate acknowledgment messages in response to receipt of packet data from the SGSN.

18. The system of claim 17
wherein the SGSN is further adapted to generate charging information in response to receipt of the acknowledgment messages from the RNC.

19. The system of claim 16
wherein the SGSN is adapted to generate acknowledgment messages in response to receipt of packet data from the GGSN.

20. The system of claim 19
wherein the GGSN is further adapted to generate charging information in response to receipt of the acknowledgment messages from the SGSN.
